(19) United States
(12) Patent Application Publication
(10) Pub. No.: US 2012/0011287 A1
(43) Pub. Date: Jan. 12, 2012

(54) PORT EXPANDER WITH CONNECTION IDENTIFICATION

(75) Inventors: Ping-Shun Zeung, Taipei City (TW); Chien-Kuan Ho, Taipei City (TW)

(73) Assignee: I/O Interconnect, Ltd.

(21) Appl. No.: 13/236,556

(22) Filed: Sep. 19, 2011

Related U.S. Application Data
(63) Continuation-in-part of application No. 12/765,837, filed on Apr. 22, 2010.

(51) Int. Cl. G06F 3/00

(52) U.S. Cl. 710/16

(57) ABSTRACT

The port expander such as a USB hub or dock has a control unit and a plurality of input/output (I/O) ports and is used to connect a computer. An application program corresponding to the hub is installed to the computer. The control unit detects whether one of the ports is connected to an external device. The control unit identifies the external device if it has connected to the I/O port and reports a connection status of the I/O port to the program in the computer. Finally, the program shows the connection status of the I/O port and the external device.

### CROSS-REFERENCE TO RELATED APPLICATIONS

This is a continuation-in-part of U.S. patent application Ser. No. 12/765,837, filed Apr. 22, 2010.

### BACKGROUND OF THE INVENTION

1. Field of the Invention

The present invention relates to personal computers, and more particularly to docking stations for portable computers.

2. Description of the Prior Art

USB (Universal Serial Bus) is a specification to establish communication between external devices and a computer system, and is intended to replace many varieties of serial and parallel ports. USB can connect various external devices such as mice, keyboards, digital cameras, printers, personal media players, flash drives, and external hard drives, and supports plug and play (PNP) function. As a result, for many of those devices, USB has become the standard connection method.

A dock, also known as port replicator or docking station, provides a simplified way of “plugging-in” a laptop computer to common peripherals. Because a wide range of dockable devices, from mobile telephones to wireless mice, have different connectors, power signaling, and uses, docks are not standardized and are therefore often designed with a specific make and model of a device in mind Usually, a dock is provided with a plurality of USB ports, DVI ports, HDMI ports and analog ports such as audio ports and offers additional connectivity for connecting more external devices. Similarly, a USB hub offers a plurality USB ports without additional ports other than USB ports. Thus docks or USB hubs may be named as “port expander”.

Whether an external device is connected to a port expander or directly to a computer, it can work normally. In principle, a user may connect an external device to a port expander or a computer. Those external devices which are directly connected to a computer can be identified by the operating system thereof The operating system can see the external device and which port it connects to. However, when an external device is connected to a port expander, the operating system can only see the external device itself but cannot find which port it connects to even if it can work normally. When a user wants to know the connection status of the ports of the port expander, he or she has to use his or her eyes and hands to confirm. That may cause inconvenience.

### SUMMARY OF THE INVENTION

It is therefore an objective of the present invention to provide a port expander capable of monitoring connection status of external devices of the port expander and a method thereof

To accomplish the above objective, the port expander of the invention has a control unit and a plurality of input/output (I/O) ports and is used to connect a computer. An application program corresponding to the hub is installed to the computer. The control unit detects whether one of the ports is connected to an external device. The control unit identifies the external device if it has connected to the port and reports a connection status of the port to the program in the computer. Finally, the program shows the connection status of the ports and the external device.

### BRIEF DESCRIPTION OF THE DRAWINGS

FIG. 1 is a schematic diagram of a port expander of the present invention and a computer; and

FIG. 2 is a flowchart of the method of the present invention.

### DETAILED DESCRIPTION OF THE INVENTION

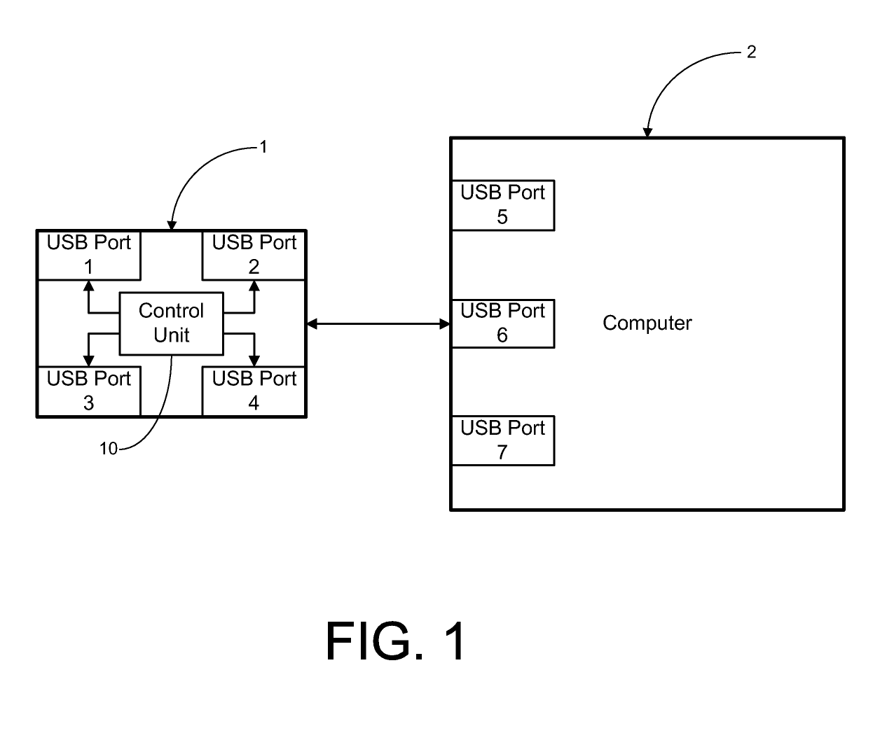

Please refer to FIG. 1, which is a schematic diagram of a port expander 1 of the invention. As abovementioned, the port expander 1 may be a USB hub or a dock for providing more USB ports. The port expander 1 can be connected to a computer 2 with USB ports 5-7. The computer 2 may be a laptop or desktop computer. The port expander 1 includes a control unit 10 and four USB ports 1-4. The USB ports are only for an exemplary expression, any other input/output (I/O) ports are also available. The control unit 10 may be a USB hub IC or a USB controller under the USB hub IC. The I/O ports 1-4 may be converted into different ports such as a Digital Visual Interface (DVI) port, a printer port, a network port, a telephone jack, an audio port, a modem port, a Personal System/2 (PS/2) port, a IEEE 1394 port, and a RS-232 port for connecting with various external devices, such as a printer, a microphone, a speaker, a monitor, a hard drive, an Ethernet, a mouse, a keyboard, etc. The control unit 10 is coupled to the USB ports 1-4 is responsible for performing an enumeration process to the computer 2 and for a hub function. The control unit 10 is coupled to the USB ports 1-4, and is used for electrically connecting the USB ports 1-4 with the USB port 6 of the computer 2.

For an operation between the port expander 1 and the computer 2, when the port expander 1 is connected to the computer 2 through the USB port 6, the control unit 10 is enumerated to the computer 2, and sends hub information to the computer 2. The enumeration process comprises a device description, such as Vendor identification (VID)/Product identification (PDI) of the port expander 1 required by the computer 2. After requiring necessary information from the port expander 1, the computer 2 can communicate with the port expander 1. Therefore, when an external device (e.g. a mouse) is plugged into one of the USB ports 1-4, the computer 2 can access the external device through the port expander 1.

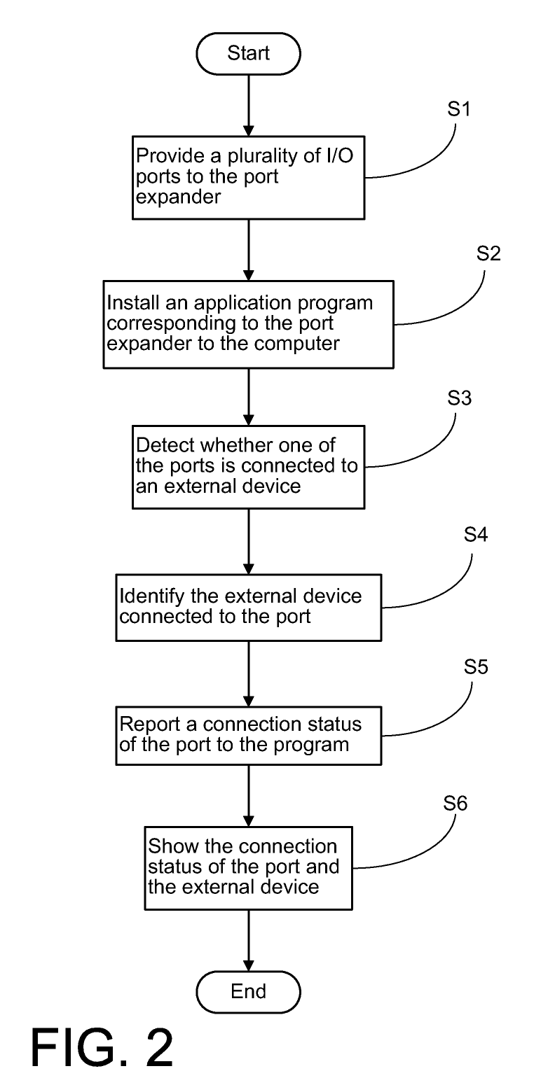

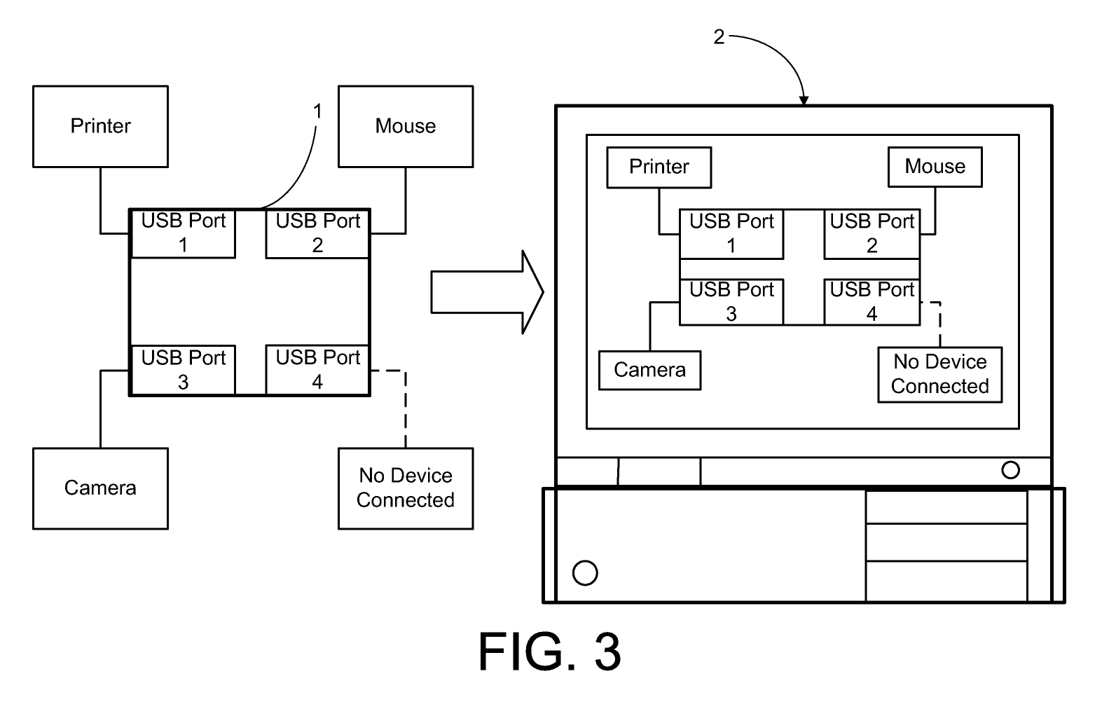

Please refer to FIG. 2. The invention provides a method for monitoring statuses of the USB ports 1-4 of the port expander. In step S1, the port expander 1 is provided with a plurality of input/output (I/O) ports such as USB ports. In step S2, an application program corresponding to the port expander 1 is installed to the computer 2. In step S3, the control unit 10 of the port expander 1 detects whether one of the ports 1-4 is connected to an external device (not shown). In step S4, the control unit 10 identifies the external device connected to the port. In step S5, the control unit 10 reports a connection status of the port to the application program in the computer 2. Finally, in step S6, the computer 2 shows the connection status of the port and the external device through a splash window 3. The information of the connection status in the splash window includes a name of the external device and the I/O port connected by the external device. Furthermore, the splash window may diagram connectivity and the physical position of the I/O ports of the port expander 1 as shown in FIG. 3.

The control unit 10 can see and identify the external device connected to one of the USB ports 1-4 of the port expander 1 according to the USB specification. Perhaps, the port expander 1 may contain analog ports other than USB, such as audio ports. For those analog ports, the control unit may see the connection status through a mechanic switch or electric character. In some cases, an external device can be found by an additional detecting pin electrically connected to each of the I/O ports.

In conclusion, the exemplary methods and means are provided to detect connection statuses of different ports on the port expander. In addition, the invention reveals a way of monitoring connection status of the port expander in software (e.g. the splash screen) aspect. As a result, the user can know the connection status of the ports with information on screen instead of checking the ports of the port expander one by one, thereby increasing usage of convenience.

Those skilled in the art will readily observe that numerous modifications and alterations of the device and method may be made while retaining the teachings of the invention.

What is claimed is:

1. A method for identifying connection status of a port expander coupled to a computer, the method comprising the steps of:
providing a plurality of input/output (I/O) ports to the port expander;
installing an application program corresponding to the port expander to the computer;
detecting whether one of the I/O ports is connected to an external device;
identifying the external device connected to the I/O port;
reporting a connection status of the I/O port to the program in the computer; and
showing the connection status of the I/O port and the external device.

2. The method of claim 1, wherein the port expander is a dock.

3. The method of claim 1, wherein the port expander is a USB (universal serial bus) hub.

4. The method of claim 1, wherein the I/O ports are USB (universal serial bus) ports.

5. The method of claim 1, wherein the connection status includes the external device and the I/O port connected by the external device.

6. The method of claim 5, wherein connection status further includes a name of the external device, connectivity between the external device and the port expander, and a physical position of the expander to which the external device is connected.

7. A port expander for a computer, comprising:
a plurality of ports; and
a control unit for detecting whether one of the plurality of input/output (I/O) ports is connected to an external device and reporting a connection status of the I/O port to the computer when the I/O port is detected to be connected to the external device.

8. The port expander of claim 7, wherein the port expander is a dock.

9. The port expander of claim 7, wherein the port expander is a USB (universal serial bus) hub.

10. The method of claim 7, wherein the I/O ports are USB (universal serial bus) ports.
